(19) United States
(12) Patent Application Publication
(10) Pub. No.: US 2019/0043140 A1
(43) Pub. Date: Feb. 7, 2019

(54) Method and System of Socially Networking Night-life Services

(71) Applicant: Tip Her LLC, Philadelphia, PA (US)

(72) Inventor: John F. Williams, Philadelphia, PA (US)

(21) Appl. No.: 16/057,781

(22) Filed: Aug. 7, 2018

Related U.S. Application Data
(60) Provisional application No. 62/542,034, filed on Aug. 7, 2017.

(51) Int. Cl. G06Q 50/00; H04W 4/021

(52) U.S. Cl. CPC G06Q 50/01; H04W 4/021

(57) ABSTRACT

A system and a method allow a client to communicate with a service provider of night-life services. A client is able to select a desired service provider in order to receive night-life services. The client is able to view when a desired service provider is available through geo-fenced locations. The client is sent a notification when a desired service provider is within a geo-fenced location. The client can interact and communicate with the desired service provider through a calling process or messaging process. The client can additionally schedule appointment with the desired service provider. The desired service provider is able to upload files to visually advertise himself or herself. The desired service provider can additionally update a work schedule which allows clients to know when a desired service provider is available.

The current application claims a priority to the U.S. Provisional Patent application Ser. No. 62/542,034 filed on Aug. 7, 2017.

### FIELD OF THE INVENTION

The present invention relates generally to a social media service. More specifically, the present invention is a method and system of socially networking night-life services such as, but not limited to, adult entertainers, exotic dancers, or bartenders. The present invention enables night-life service providers to connect to their clients and to their employers, thus facilitating communication of information such as working hours and locations between clients, performers, and clubs.

### BACKGROUND OF THE INVENTION

The advent of social media services started a large number of more niche social media services. Such services enable people with similar backgrounds and social needs to interact with each other online. Instagram enables users to share images with their friends and associates, Facebook allows people to stay connected, and Twitter enables users to share concise news and thoughts with their followers. A variety of other apps and services similarly connect people with similar interests. Similarly, there are many applications and services that connect employees, employers, and clients, facilitating communication and exchange of services.

While many services have been invented to connect niche groups, none of these services include connection between adult entertainers, such as exotic dancers and strippers, and their clients. Further, there is a distinct lack of a service that publicly displays hours and scheduling information for such workers, and enables those workers to communicate with their employers, allowing all participants to be updated instantly as to the location and availability of workers. What is needed is a social media service that enables users to discover, follow, and communicate with adult entertainers, and to discover new club locations as well.

The present invention addresses these issues. The present invention is a method and system of socially networking night-life services. In more detail, the present invention provides an application that enables users to connect with their favorite night-life service providers. Entertainers also have the ability to communicate with repeat clients, and to block communications with clients who send aggressive or distasteful messages. Users, entertainers, and clubs can each create accounts under the same application, enabling each to communicate with the others. Users can schedule appointments with performers, performers can advertise themselves, and clubs can promote events and coordinate schedules with performers. This enables users to get to know new entertainers before seeking them out, and to know who's working on a given night.

### BRIEF DESCRIPTION OF THE DRAWINGS

FIG. 1 is a block diagram illustrating the system of the present invention.

FIG. 2A is a flowchart illustrating the overall process for the method of the present invention.

FIG. 2B is a continuation of the flowchart illustrated in FIG. 2A

FIG. 3 is a flowchart illustrating a sub-process for selecting a desired account after searching for a specific service account.

FIG. 4 is a flowchart illustrating a sub-process for selecting a desired account after searching for service accounts associated to a specific geo-fenced location.

FIG. 5 is a flowchart illustrating a sub-process for monitoring the location of a desired account through the (GPS) module of the corresponding MC device.

FIG. 6 is a flowchart illustrating a sub-process for sending an active notification.

FIG. 7 is a flowchart illustrating a sub-process for tipping between users of a client account and a service account.

FIG. 8 is a flowchart illustrating a sub-process for scheduling an appointment between users of a client account and a service account.

FIG. 9 is a flowchart illustrating a sub-process for calling between users of a client account and a service account.

FIG. 10 is a flowchart illustrating a sub-process for messaging between users of a client account and a service account.

FIG. 11 is a flowchart illustrating a sub-process for updating an availability schedule of a specific service account.

FIG. 12 is a flowchart illustrating a sub-process for uploading a publicly-viewable file for a specific service account.

FIG. 13 is a flowchart illustrating a sub-process for uploading a privately-viewable file for a specific service account.

### DETAIL DESCRIPTIONS OF THE INVENTION

All illustrations of the drawings are for the purpose of describing selected versions of the present invention and are not intended to limit the scope of the present invention.

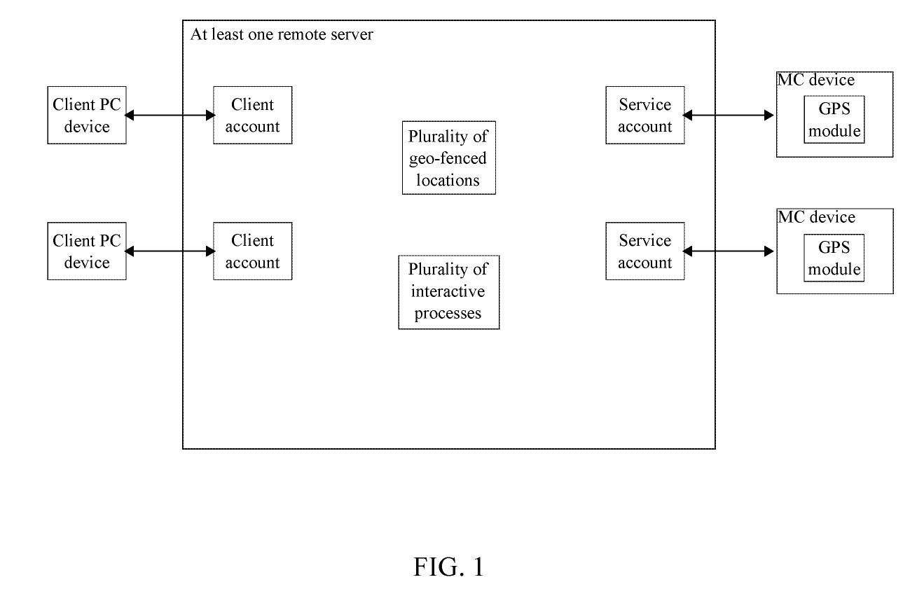

The present invention is a method and system of socially networking night-life services. In further detail, the present invention is a software application that allows a consumer to communicate with a service provider of night-life services such as, but not limited to, an adult entertainer or bartender. With reference to FIG. 1, the system of the present invention is provided with at least one remote server that manages at least one client account and a plurality of service accounts. The at least one client account and the plurality of service accounts allow the present invention to identify each person that is using and interacting with the present invention. The remote server is used as a hub to exchange information between the at least one client account and the plurality of service accounts, to store data provided by the at least client account and the plurality of service accounts, and to manage the administrative processes of the present invention. Furthermore, the at least one client account is associated with a client personal computing (PC) device (Step A). The client PC device allows each person with a client account to interact and use the present invention. The client PC device can be, but is not limited to, a desktop, a laptop, a smart-phone, or a tablet personal computer. Similarly, each plurality of service accounts is associated with a corresponding mobile computing (MC) device (Step B). The corresponding MC device allows each person with a service account to interact and use the present invention. The corresponding MC device is preferably a smart-phone. Additionally, the remote server manages a plurality of geo-fenced locations and a plurality of interactive processes (Step C). Each of the plurality of geo-fenced locations is physical location with a virtually geographic boundary that triggers a response when a smart-phone with global positioning system (GPS) capabilities enters or leaves the physical location. The plurality of interactive processes allows each user with a client account to communicate with an arbitrary user of a service account.

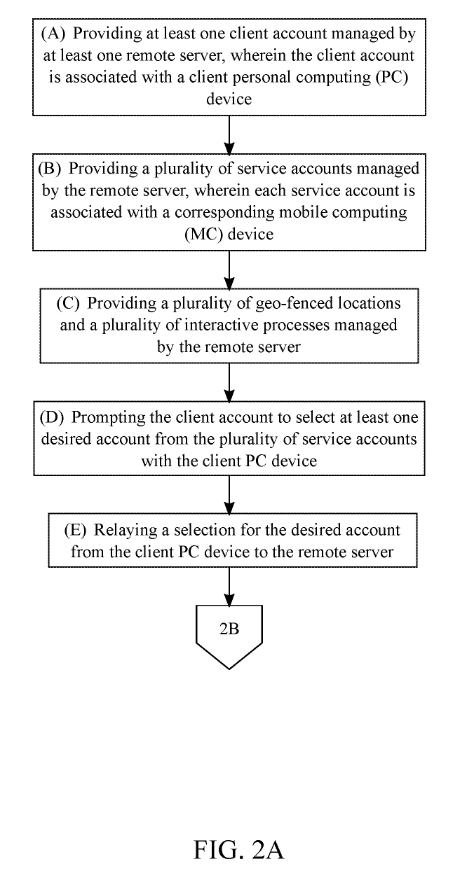

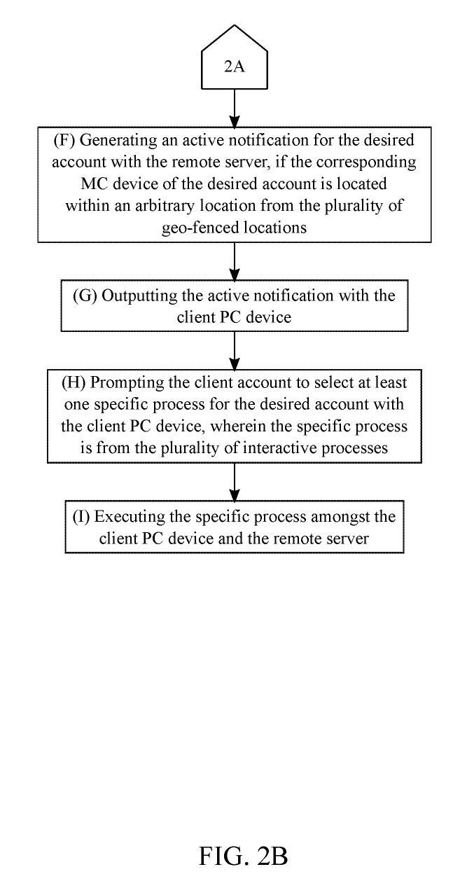

With reference to FIG. 2A and FIG. 2B, the method of socially networking night-life services follows an overall process that allows a consumer to stay in constant communication with a service provider. For the overall process, the at least one client account can be created with the client PC device and through the remote server. Before the client account is created through the remote server, the client PC device prompts the user to answer if the user is over the age of eighteen. If not, the present invention is closed immediately on the client PC device. If yes, the user is allowed to search for a geo-fenced location or a specific user of a service account. The user is then prompted to login or sign up for a client account or a service account. The login process prompts the user to enter credentials to access the present invention with the corresponding client account or service account. The signup process prompts the user to specify if this will be a client account or service account. The signup process additionally requires the user to sign an agreement. The agreement is a legal protection for the present invention that asks the user to confirm that he or she will not send disrespectful messages, upload inappropriate images, or otherwise abuse the present invention. Subsequently, the signup process prompts the user to enter details such as, but not limited to, the user's name, username, date of birth, email, address information, and to set a password. In addition, the user may upload payment information such as, but not limited to, credit card information or a bank account information. The client PC device then prompts the client account to select at least one desired account from the plurality of service accounts (Step D). The selection for the desired account is relayed from the client PC device to the remote server (Step E). The remote server is continuously monitoring for when each service account enters a geo-fenced location, and, if the corresponding MC device of the desired account is located within an arbitrary location from the plurality of geo-fenced locations, then the remote server generates an active notification for the desired account (Step F). The active notification is used to alert and inform the client account of the arbitrary location of the desired account. The active notification is outputted with the client PC device (Step G) as either an audible or visual alert. In addition, the client PC device prompts the client account to select at least one specific process for the desired account with the client PC device, wherein the specific process is from the plurality of interactive processes (Step H). This allows the client account to choose how to interact with the desired account through the present invention. The specific process is executed amongst the client PC device and the remote server (Step I) so that the client account is able to further interact with the desired account than just receiving the active notification for the desired account.

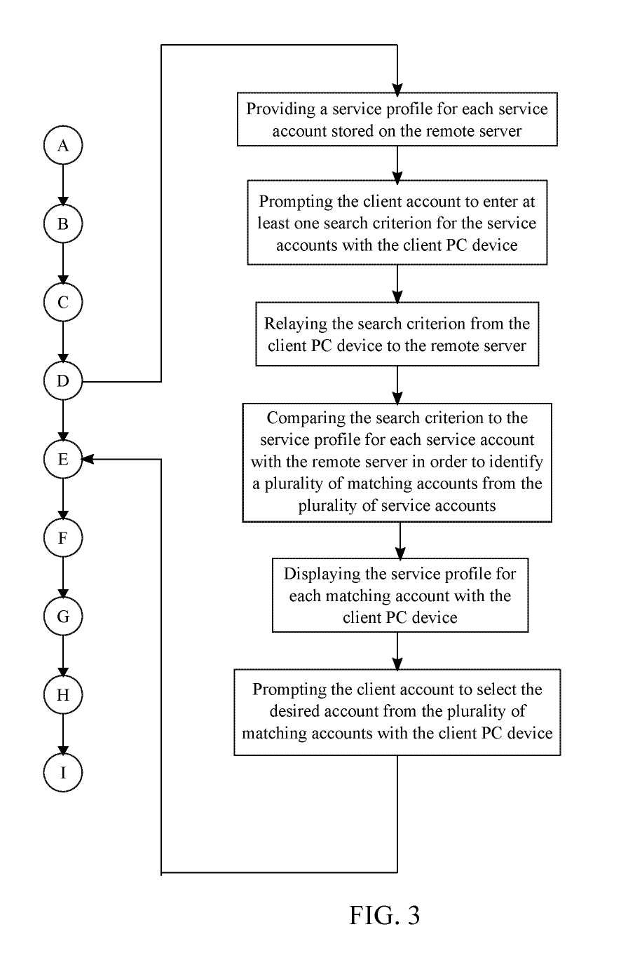

A sub-process followed by the method provides a service profile for each service account that is stored on the remote server, which is shown in FIG. 3. The service profile is the personal data associated with each user of a service account. The client PC device prompts the client account to enter at least one search criterion for the service accounts. The search criterion may be a city, a state, a zip code, or the name of a service provider. The search criterion from the client PC device is then relayed to the remote server. Subsequently, the remote server compares the search criterion to the service profile for each service account in order to identify a plurality of matching accounts from the plurality of service accounts. Each of the plurality of matching accounts is physically located near the vicinity of the client account or the entered search criterion. The client PC device displays the service profile for each matching account. The client PC device preferably displays each service profile in a list format. The client PC device prompts the client account to select a desired account from the plurality of matching accounts.

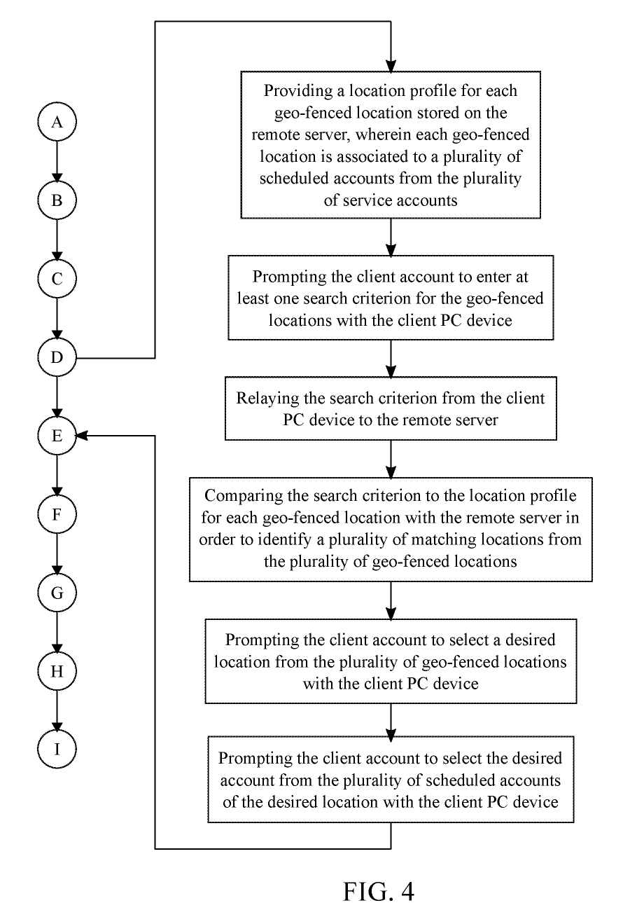

Another sub-process followed by the method provides a location profile for each geo-fenced location that is stored on the remote server, wherein each geo-fenced location is associated to a plurality of scheduled accounts from the plurality of service accounts, which is shown in FIG. 4. Each of the plurality of scheduled accounts is associated with a user of service account that is employed by the corresponding geo-fenced location. The location profile preferably provides descriptive information about a geo-fenced location, such as, but not limited to, information about services rendered, the name of the establishment, and the hours. The geo-fenced locations are typically strip clubs, dance clubs, or other night-life establishment. The client PC device then prompts the client account to enter at least one search criterion for the geo-fenced locations. The search criterion may be a city, a state, a zip code, or a specific name of a geo-fenced location. Afterwards, the search criterion is relayed from the client PC device to the remote server. The remote server compares the search criterion to the location profile for each geo-fenced location in order to identify a plurality of matching locations from the plurality of geo-fenced locations. Each of the plurality of matching locations is physically located near the vicinity of the client account or the entered search criterion. The client PC device prompts the client account to select a desired location from the plurality of geo-fenced locations, which allows the client account to view the scheduled accounts of the desired location. The client PC device then prompts the client account to select the desired account from the plurality of scheduled accounts of the desired location.

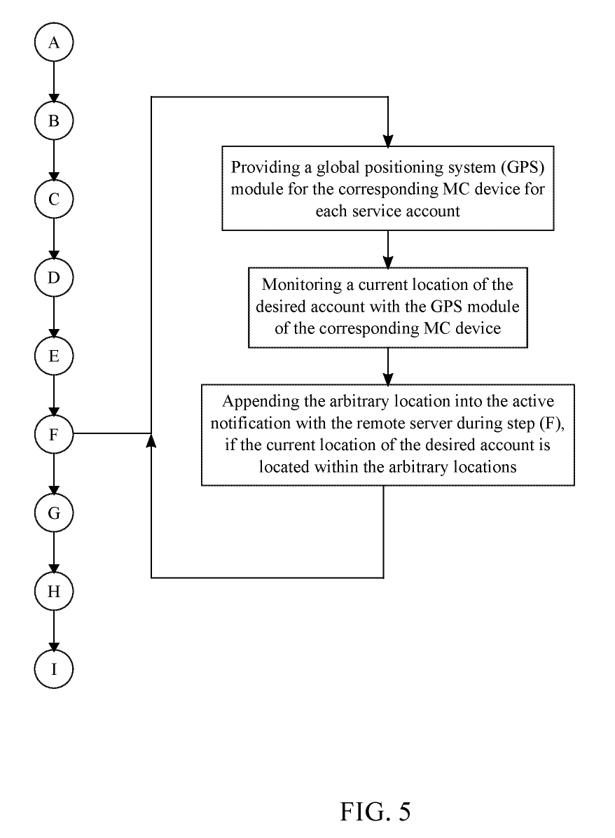

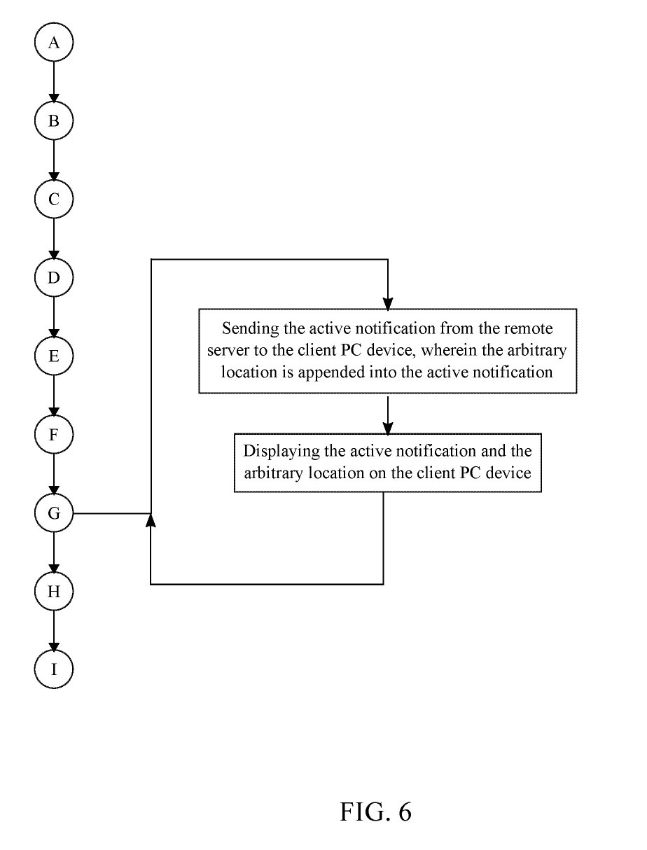

In order for the remote server to monitor the location of the desired account and as seen in FIG. 5, the system of the present invention additionally includes a global positioning system (GPS) module for the corresponding MC device for each service account. The GPS module of the corresponding MC device monitors a current location of the desired account. The remote server appends the arbitrary location into the active notification during Step F if the current location of the desired account is located within the arbitrary locations. This sub-process triggers a response to the user of the client account when the desired account enters or leaves an arbitrary geo-fenced location. As seen in FIG. 6, the remote server sends the active notification to the client PC device, wherein the arbitrary location is appended into the active notification. The client PC device displays the active notification and the arbitrary location. The client account preferably includes a notification feature, wherein multiple active notifications are displayed to the client account on the client PC device.

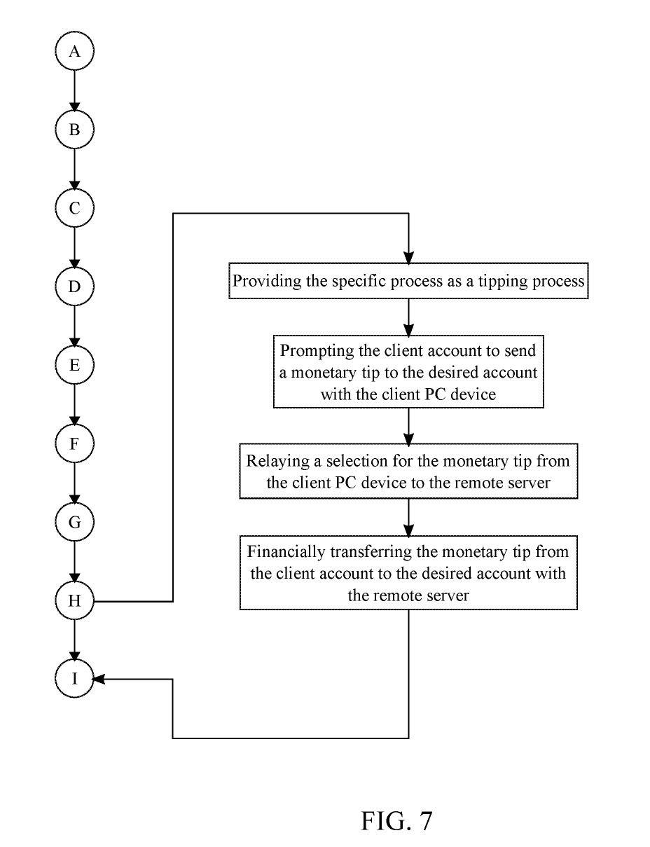

Another sub-process followed by the method allows a client account to financially compensate a service provider of a service account and provides the specific process as a tipping process, which is shown in FIG. 7. The client PC device prompts the client account to send a monetary tip to the desired account. The monetary tip may be any type of currency such as, but not limited to, United States dollars or cryptocurrency. The selection for the monetary tip is relayed from the client PC device to the remote server. The remote server then financially transfers the monetary tip from the client account to the desired account. This specific process allows the client to tip the service provider for any services.

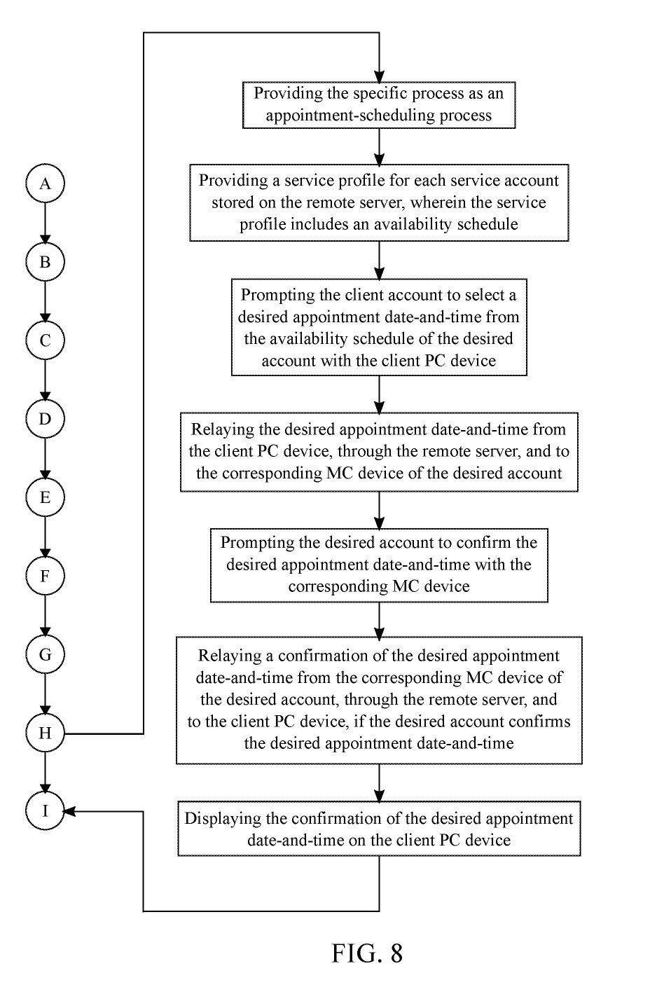

Another sub-process followed by the method allows a client to schedule a date-and-time for service with a service provider and provides the specific process as an appointment-scheduling process, which is shown in FIG. 8. The service profile for each service account, stored on the remote server, includes an availability schedule. The client PC device prompts the client account to select a desired appointment date-and-time from the availability schedule of the desired account. The user of the client account may want to setup a desired appointment date-and-time in order to receive a private service such as, but not limited to, a lap dance or bartending. The desired appointment date-and-time is relayed from the client PC device, through the remote server, and to the corresponding MC device of the desired account. The corresponding MC device then prompts the desired account to confirm the desired appointment date-and-time. The confirmation of the desired appointment date-and-time is relayed from the corresponding MC device of the desired account, through the remote server, and to the client PC device, if the desired account confirms the desired appointment date-and-time. The client PC device displays the confirmation of the desired appointment date-and-time. The client and the service provider have setup and confirmed a date-and-time for the appointment when the confirmation is displayed on the client PC device. If the desired account denies the desired appointment date-and-time, the client is notified and may attempt to schedule another appointment. Both the client and the service provider may view any scheduled appointments through a scheduled appointment feature of the present invention.

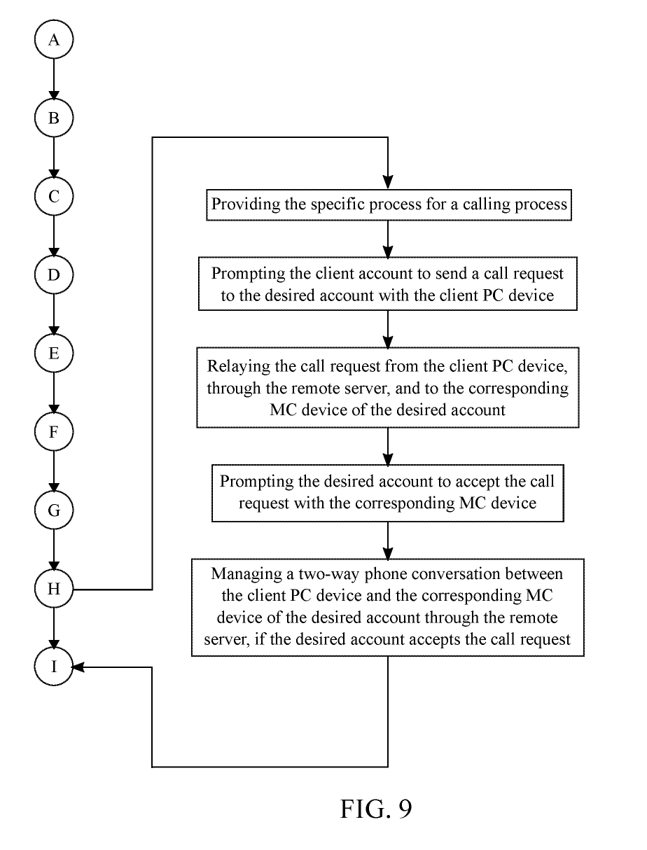

Another sub-process following the method allows a client to communicate vocally with a service provider and provides the specific process for a calling process, which is shown in FIG. 9. The calling process can be accessed by a client or a service provider through a calling feature of the present invention. The calling feature additionally allows each user with a client account or with a service account to view his or her call history. The client PC device prompts the client account to send a call request to the desired account. The call request is relayed from the client PC device, through the remote server, and to the corresponding MC device of the desired account. The corresponding MC device then prompts the desired account to accept the call request. The remote server manages a two-way phone conversation between the client PC device and the corresponding MC device of the desired account, if the desired account accepts the call request. The calling process can be used by a user of client account by purchasing talk minutes through the tipping process.

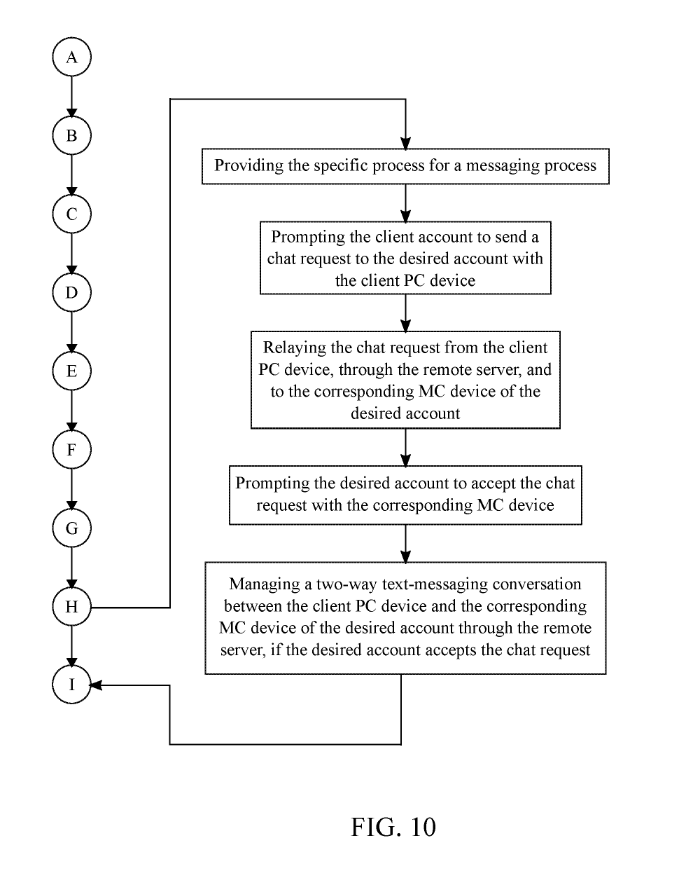

Another sub-process allows a client to communicate textually with a service provider and provides the specific process for a messaging process, which is shown in FIG. 10. The messaging process can be accessed a client or a service provider through a messaging feature of the present invention. The messaging feature additionally allows each user with a client account or with a service account to view his or her messaging history. The client PC device prompts the client account to send a chat request to the desired account. The chat request is relayed from the client PC device, through the remote server, and to the corresponding MC device of the desired account. The corresponding MC device then prompts the desired account to accept the chat request. The remote manages a two-way text-messaging conversation between the client PC device and the corresponding MC device of the desired account, if the desired account accepts the chat request. In addition, the present invention allows a client or service provider to respectively block a specific service account or specific client account, if the client or the service provider does not wish to communicate with the specific service account or specific client account.

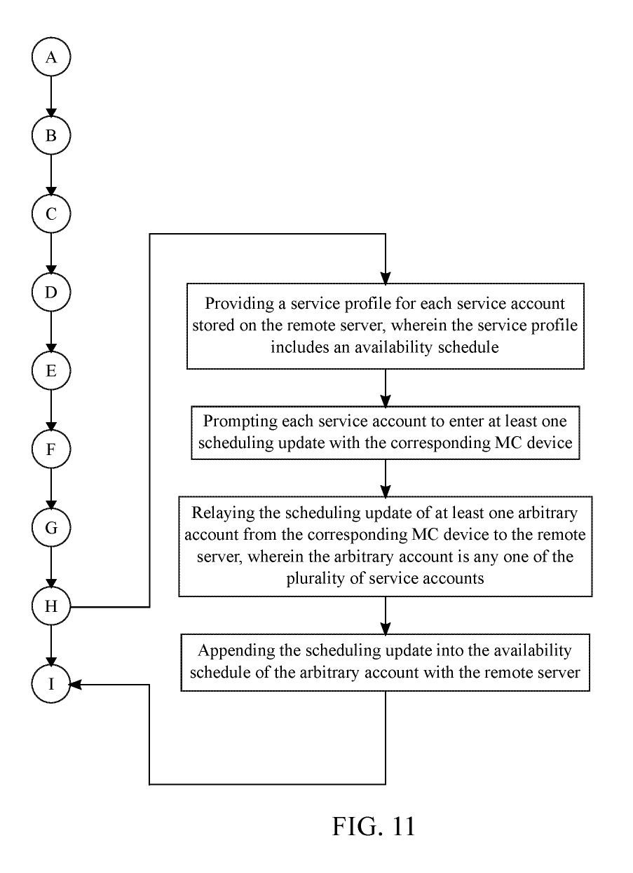

In order for each user with a service account to provide his or her availability and as seen in FIG. 11, the service profile for each service account, stored on the remote server, includes an availability schedule. The corresponding MC device prompts each service account to enter at least one scheduling update. The scheduling update of at least one arbitrary account is relayed from the corresponding MC device to the remote server, wherein the arbitrary account is any one of the plurality of service accounts. The remote server appends the scheduling update into the availability schedule of the arbitrary account. This allows a client to view when a service provider is available, without selecting a desired account, and to view when an appointment can be scheduled with a service provider.

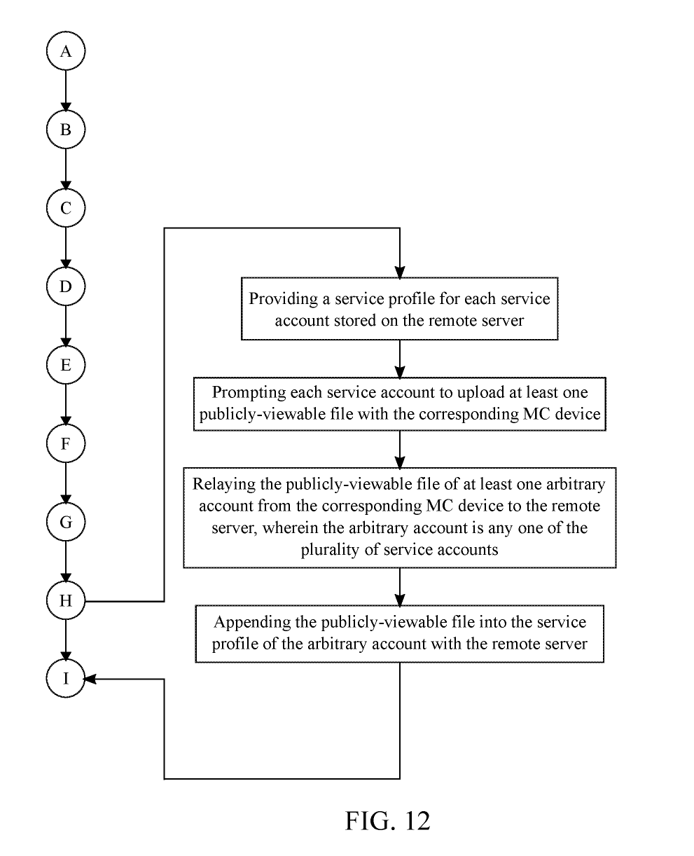

In order for each user with a service account to visually advertise himself or herself and as seen in FIG. 12, the corresponding MC device prompts each service account to upload at least one publicly-viewable file. The at least one publicly-viewable file allows each user with a service account to visually advertise himself or herself to users with a client account. The publicly-viewable file must contain only appropriate material. The publicly-viewable file can any type of file such as, but not limited to, a photo or video. The publicly-viewable file of at least one arbitrary account is relayed from the corresponding MC device to the remote server, wherein the arbitrary account is any one of the plurality of service accounts. The remote server appends the publicly-viewable file into the service profile of the arbitrary account. The publicly-viewable file can be viewed on the service profile of the arbitrary account.

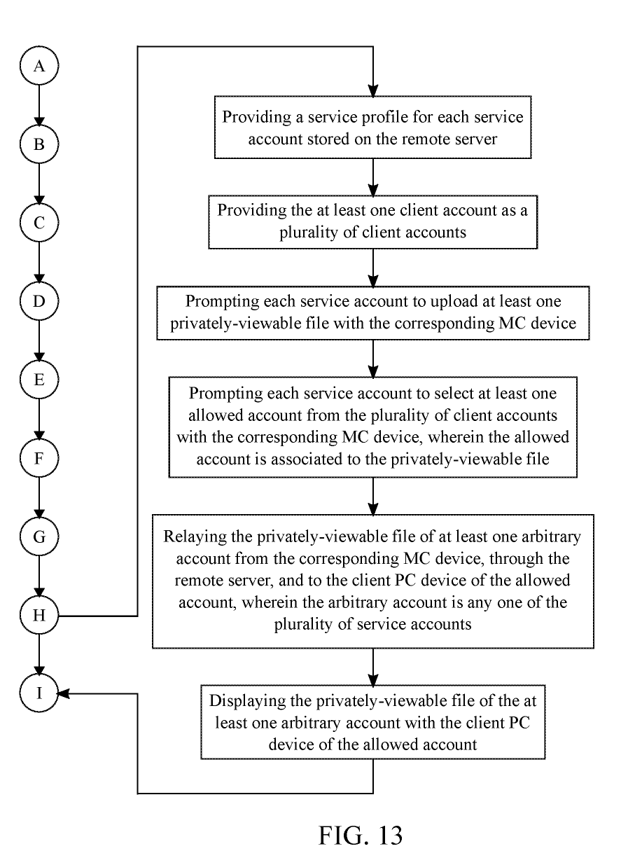

In order for each user of service to potentially communicate with multiple users with a client account and as seen in FIG. 13, the at least one client account can be a plurality of client accounts. The corresponding MC device prompts each service account to upload at least one privately-viewable file. The privately-viewable file is necessary for each user with a service account to distinctively compensate specific users with a client account who purchase premium services. The privately-viewable file can any type of file such as, but not limited to, a photo or video. The corresponding MC device prompts each service account to select at least one allowed account from the plurality of client accounts, wherein the allowed account is associated to the privately-viewable file. The privately-viewable file of at least one arbitrary account is relayed from the corresponding MC device, through the remote server, and to the client PC device of the allowed account, wherein the arbitrary account is any one of the plurality of service accounts. The client PC device of the allowed account displays the privately-viewable file of the least one arbitrary account. This allows a service provider to send privately-viewable files to a specific client through the messaging process or allows a client to view the privately-viewable files on the service profile if the client purchases the option. In addition, the present invention allows the client to purchase upgraded services in order to receive unlimited talk minutes, and view unlimited privately-viewable files such as, but not limited to, photos or videos.

Although the invention has been explained in relation to its preferred embodiment, it is to be understood that many other possible modifications and variations can be made without departing from the spirit and scope of the invention as hereinafter claimed.

What is claimed is:

1. A method of socially networking night-life services, the method comprises the steps of:
(A) providing at least one client account managed by at least one remote server, wherein the client account is associated with a client personal computing (PC) device;
(B) providing a plurality of service accounts managed by the remote server, wherein each service account is associated with a corresponding mobile computing (MC) device;
(C) providing a plurality of geo-fenced locations and a plurality of interactive processes managed by the remote server;
(D) prompting the client account to select at least one desired account from the plurality of service accounts with the client PC device;
(E) relaying a selection for the desired account from the client PC device to the remote server;
(F) generating an active notification for the desired account with the remote server, if the corresponding MC device of the desired account is located within an arbitrary location from the plurality of geo-fenced locations;
(G) outputting the active notification with the client PC device;
(H) prompting the client account to select at least one specific process for the desired account with the client PC device, wherein the specific process is from the plurality of interactive processes; and
(I) executing the specific process amongst the client PC device and the remote server.

2. The method of socially networking night-life services, the method as claimed in claim 1 comprises the steps of:
providing a service profile for each service account stored on the remote server;
prompting the client account to enter at least one search criterion for the service accounts with the client PC device;
relaying the search criterion from the client PC device to the remote server;
comparing the search criterion to the service profile for each service account with the remote server in order to identify a plurality of matching accounts from the plurality of service accounts;
displaying the service profile for each matching account with the client PC device; and
prompting the client account to select the desired account from the plurality of matching accounts with the client PC device.

3. The method of socially networking night-life services, the method as claimed in claim 1 comprises the steps of:
providing a location profile for each geo-fenced location stored on the remote server, wherein each geo-fenced location is associated to a plurality of scheduled accounts from the plurality of service accounts;
prompting the client account to enter at least one search criterion for the geo-fenced locations with the client PC device;
relaying the search criterion from the client PC device to the remote server;
comparing the search criterion to the location profile for each geo-fenced location with the remote server in order to identify a plurality of matching locations from the plurality of geo-fenced locations;
prompting the client account to select a desired location from the plurality of geo-fenced locations with the client PC device; and
prompting the client account to select the desired account from the plurality of scheduled accounts of the desired location with the client PC device.

4. The method of socially networking night-life services, the method as claimed in claim 1 comprises the steps of:
providing a global positioning system (GPS) module for the corresponding MC device for each service account;
monitoring a current location of the desired account with the GPS module of the corresponding MC device; and
appending the arbitrary location into the active notification with the remote server during step (F), if the current location of the desired account is located within the arbitrary locations.

5. The method of socially networking night-life services, the method as claimed in claim 1 comprises the steps of:
sending the active notification from the remote server to the client PC device, wherein the arbitrary location is appended into the active notification; and
displaying the active notification and the arbitrary location on the client PC device.

6. The method of socially networking night-life services, the method as claimed in claim 1 comprises the steps of:
providing the specific process as a tipping process;
prompting the client account to send a monetary tip to the desired account with the client PC device;
relaying a selection for the monetary tip from the client PC device to the remote server; and
financially transferring the monetary tip from the client account to the desired account with the remote server.

7. The method of socially networking night-life services, the method as claimed in claim 1 comprises the steps of:
providing the specific process as an appointment-scheduling process;
providing a service profile for each service account stored on the remote server, wherein the service profile includes an availability schedule;
prompting the client account to select a desired appointment date-and-time from the availability schedule of the desired account with the client PC device;
relaying the desired appointment date-and-time from the client PC device, through the remote server, and to the corresponding MC device of the desired account;
prompting the desired account to confirm the desired appointment date-and-time with the corresponding MC device;
relaying a confirmation of the desired appointment date-and-time from the corresponding MC device of the desired account, through the remote server, and to the client PC device, if the desired account confirms the desired appointment date-and-time; and
displaying the confirmation of the desired appointment date-and-time on the client PC device.

8. The method of socially networking night-life services, the method as claimed in claim 1 comprises the steps of:
providing the specific process for a calling process;
prompting the client account to send a call request to the desired account with the client PC device;
relaying the call request from the client PC device, through the remote server, and to the corresponding MC device of the desired account;
prompting the desired account to accept the call request with the corresponding MC device; and
managing a two-way phone conversation between the client PC device and the corresponding MC device of the desired account through the remote server, if the desired account accepts the call request.

9. The method of socially networking night-life services, the method as claimed in claim 1 comprises the steps of:
providing the specific process for a messaging process;
prompting the client account to send a chat request to the desired account with the client PC device;
relaying the chat request from the client PC device, through the remote server, and to the corresponding MC device of the desired account;
prompting the desired account to accept the chat request with the corresponding MC device; and
managing a two-way text-messaging conversation between the client PC device and the corresponding MC device of the desired account through the remote server, if the desired account accepts the chat request.

10. The method of socially networking night-life services, the method as claimed in claim 1 comprises the steps of:
providing a service profile for each service account stored on the remote server, wherein the service profile includes an availability schedule;
prompting each service account to enter at least one scheduling update with the corresponding MC device;
relaying the scheduling update of at least one arbitrary account from the corresponding MC device to the remote server, wherein the arbitrary account is any one of the plurality of service accounts; and
appending the scheduling update into the availability schedule of the arbitrary account with the remote server.

11. The method of socially networking night-life services, the method as claimed in claim 1 comprises the steps of:
providing a service profile for each service account stored on the remote server;
prompting each service account to upload at least one publicly-viewable file with the corresponding MC device;
relaying the publicly-viewable file of at least one arbitrary account from the corresponding MC device to the remote server, wherein the arbitrary account is any one of the plurality of service accounts; and
appending the publicly-viewable file into the service profile of the arbitrary account with the remote server.

12. The method of socially networking night-life services, the method as claimed in claim 1 comprises the steps of:
providing a service profile for each service account stored on the remote server;
providing the at least one client account as a plurality of client accounts;
prompting each service account to upload at least one privately-viewable file with the corresponding MC device;
prompting each service account to select at least one allowed account from the plurality of client accounts with the corresponding MC device, wherein the allowed account is associated to the privately-viewable file;
relaying the privately-viewable file of at least one arbitrary account from the corresponding MC device, through the remote server, and to the client PC device of the allowed account, wherein the arbitrary account is any one of the plurality of service accounts; and
displaying the privately-viewable file of the at least one arbitrary account with the client PC device of the allowed account.
